(19) United States
(12) Patent Application Publication
(10) Pub. No.: US 2026/0370985 A1
(43) Pub. Date: Nov. 19, 2026

(54) IMAGE SENSOR USING DITHERING RAMP SIGNAL

(71) Applicant: PIXART IMAGING INC., Hsin-Chu County (TW)

(72) Inventors: Mei-Chao YEH, Hsin-Chu County (TW); Chih Pin SUN, Hsin-Chu County (TW); Chao-Chi LEE, Hsin-Chu County (TW)

(21) Appl. No.: 19/211,258

(22) Filed: May 18, 2025

(51) Int. Cl. H04N 25/77; H03K 4/08; H03M 1/06; H04N 25/709

(52) U.S. Cl. CPC H04N 25/77; H03K 4/08; H03M 1/0641; H04N 25/709

(57) ABSTRACT

There is provided an image sensor including a pixel array, multiple comparators and a ramp signal generator. The pixel array includes multiple pixel columns. The multiple comparators are arranged respectively corresponding to the multiple pixel columns, and one input terminal of each comparator is coupled to one pixel column. The ramp signal generator provides a ramp signal to the other input terminal of each comparator. The image sensor may further include an extraction current source to cause auto-zero voltages of the ramp signal to be different corresponding to different pixel columns. The image sensor may further include a random number generator to generate a random noise to be added to an offset voltage of the ramp signal corresponding to different pixel rows.

### FIELD OF THE DISCLOSURE

This disclosure generally relates to an image sensor and, more particularly, to an image sensor that uses dithering ramp signal in comparators of the analog-to-digital conversion to eliminate or at least alleviate data transfer error and quantization noises, and an operating method of the image sensor.

### BACKGROUND OF THE DISCLOSURE

The complementary metal-oxide-semiconductor (CMOS) image sensor is much more popular than the charge couple device (CCD) image sensor due to its low cost, small size and low power consumption.

The CMOS image sensor includes a plurality of opto-electrical components arranged in a matrix to generate electrical signals according to a variation of incident light intensity. The CMOS image sensor further includes analog-to-digital converters (ADCs) to convert the electrical signals to digital signals. For example, each ADC includes a comparator to compare a ramp signal with a voltage level of pixel signal, and when the ramp signal is identical to the voltage level of pixel signal, the comparator generates a digital signal to represent sensed light intensity.

However, it is noticed that the state change of comparators and the data latch of memories can interfere with data transfer during horizontal scanning to cause a data transfer error.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an image sensor that uses different auto-zero voltages of a ramp signal in comparators of multiple column ADCs to eliminate the data transfer error, and an operating method of the image sensor.

The present disclosure further provides an image sensor that uses a dithering ramp signal to eliminate the interference to horizontal scanning from the state change of comparators and the data latch of memories, and an operating method of the image sensor.

The present disclosure further provides an image sensor that uses a dithering ramp signal to generate different offset voltages to eliminate quantization noises, and an operating method of the image sensor.

The present disclosure provides an image sensor including a pixel array, multiple comparators, a ramp signal generator and an extraction current source. The pixel array includes multiple pixel columns. The multiple comparators are respectively arranged corresponding to the multiple pixel columns, and one input terminal of each comparator is coupled to one pixel column. The ramp signal generator is configured to be coupled to the other input terminal of the each comparator via a voltage line to provide a ramp signal to the each comparator. The extraction current source is configured to be coupled to the voltage line and arranged at downstream of a last comparator among the multiple comparators to extract a current from the voltage line.

The present disclosure further provides an image sensor including a pixel array, multiple comparators, a ramp signal generator and an extraction current source. The pixel array includes multiple pixel columns. The multiple comparators are respectively arranged corresponding to the multiple pixel columns, and one input terminal of each comparator is coupled to one pixel column. The ramp signal generator is configured to be coupled to the other input terminal of the each comparator via a first voltage line and a first switch, or coupled to the other input terminal of the each comparator via a second voltage line and a second switch, wherein a line resistance of the second voltage line is larger than a line resistance of the first voltage line. The extraction current source is configured to be coupled to the second voltage line and arranged at downstream of a last comparator among the multiple comparators to extract a current from the second voltage line.

The present disclosure further provides an image sensor including a pixel array, multiple comparators, a ramp signal generator and a random number generator. The pixel array includes multiple pixel columns and multiple pixel rows. The multiple comparators are respectively arranged corresponding to the multiple pixel columns, and one input terminal of each comparator is coupled to one pixel column. The ramp signal generator is configured to be coupled to the other input terminal of the each comparator via a voltage line to provide an offset voltage of a ramp signal to the each comparator. The random number generator is configured to provide different random noises to be added to the offset voltage of the ramp signal corresponding to different pixel rows to cause the offset voltage of the ramp signal to form a random offset voltage corresponding to the different rows.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic block diagram of an image sensor according to one embodiment of the present disclosure.

FIG. 2A is an operational timing diagram of an image sensor without a dithering function on an auto-zero voltage of a ramp signal according to one embodiment of the present disclosure.

FIG. 2B is an operational timing diagram of an image sensor with a dithering function on an auto-zero voltage of a ramp signal according to one embodiment of the present disclosure.

FIG. 3 is a schematic diagram of implementing a dithering auto-zero function of an image sensor according to a first embodiment of the present disclosure.

FIG. 4 is a schematic diagram of implementing a dithering auto-zero function of an image sensor according to a second embodiment of the present disclosure.

FIG. 5 is an operational timing diagram of an image sensor with a dithering function on an offset voltage of a ramp signal according to a third embodiment of the present disclosure.

FIG. 6 is a schematic block diagram of a ramp signal generator of an image sensor according to a third embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide an image sensor and an operating method thereof that use variable auto-zero voltages of a ramp signal to eliminate a data transfer error caused by the simultaneous state change of all comparators and the simultaneous data latch of all memories during analog-to-digital conversion that lead to fluctuations of system power and system ground. Another objective of the present disclosure is to provide an image sensor and an operating method thereof that use variable offset voltages of a ramp signal to eliminate quantization noises.

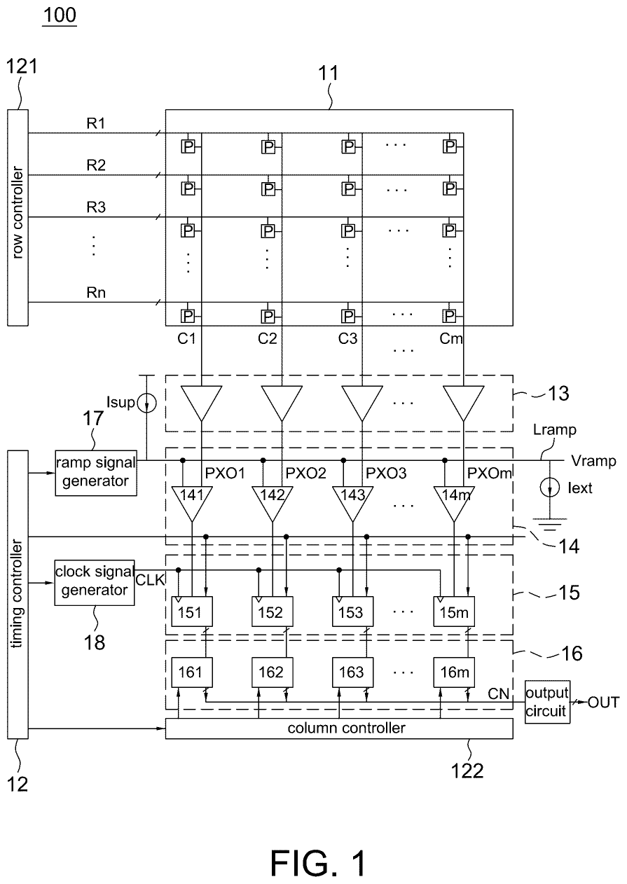

Please refer to FIG. 1, it is a schematic block diagram of an image sensor 100 according to one embodiment of the present disclosure. The image sensor 100 includes a pixel array 11, a timing controller 12, a row controller 121, a column controller 122, an amplifying circuit 13, a comparing circuit 14, a counting circuit 15, a memory circuit 16, a ramp signal generator 17 and a clock signal generator 18. The timing controller 12 is used to generate control signals to control operations of the row controller 121, the column controller 122, the ramp signal generator 17 and the clock signal generator 18.

The pixel array 11 includes multiple pixel columns and multiple pixel rows. The multiple pixel columns are used to output pixel signals via column lines C1 to Cm, and the row controller 121 is used to control the pixel array 11 via row lines R1 to Rn, wherein values of m and n are determined according to a size of the pixel array 11. The method of the pixel array 11 outputting pixel signals according to control signals from the row controller 121 is known to the art and not a main objective of the present disclosure, and thus details thereof are not described herein. The column controller 122 is used to control, according to the control of the timing controller 12, output timing of count values in every memory 161 to 16m of the memory circuit 16.

The amplifying circuit 13 includes multiple amplifiers respectively coupled to one pixel column, and the multiple amplifiers are used to receive pixel signals via the column lines C1 to Cm and to generate amplified pixel signals (abbreviated as pixel signals herein for illustration purposes), e.g., shown as PXO1, PXO2, PXO3 . . . PXOm.

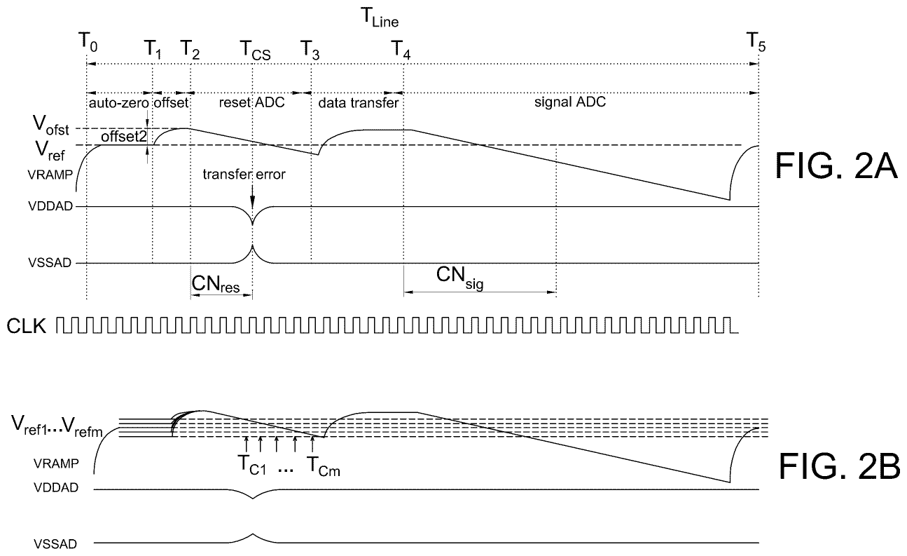

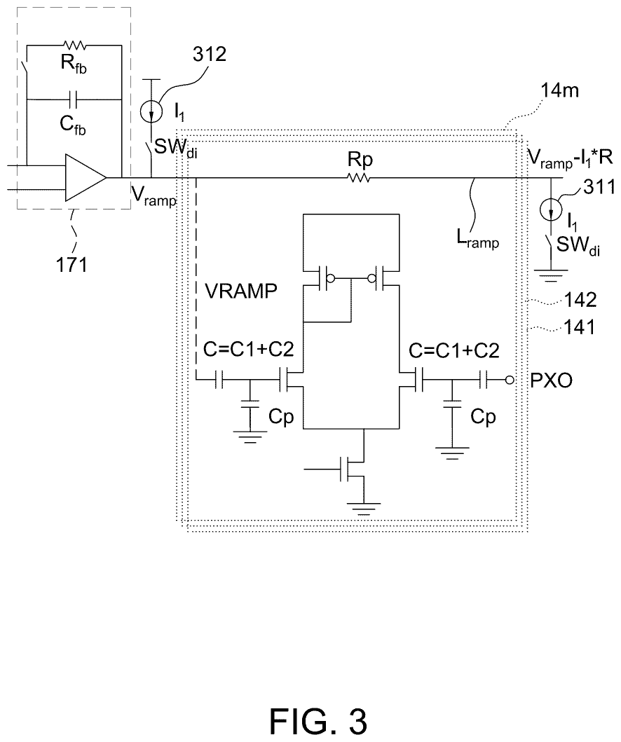

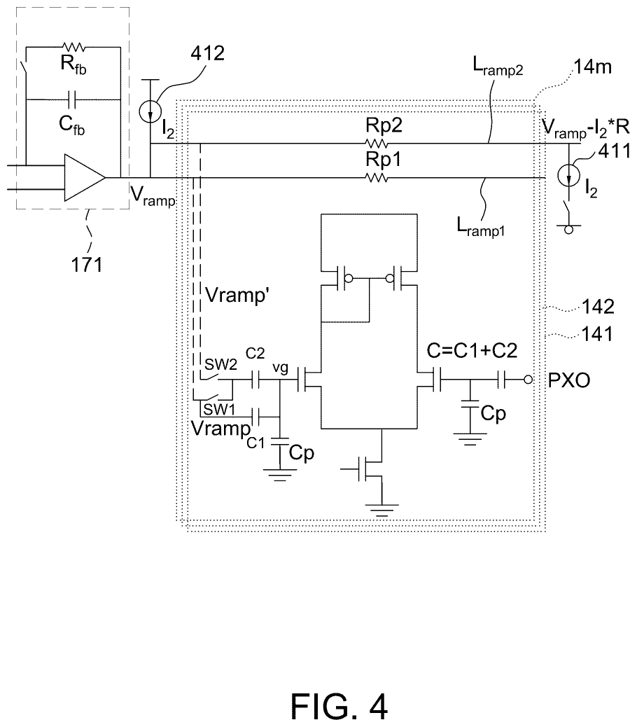

The comparing circuit 14 includes multiple comparators 141 to 14m, e.g., referring to FIG. 3 and FIG. 4. The multiple comparators 141 to 14m are respectively arranged corresponding to the multiple pixel columns, and one input terminal (e.g., the right input terminal shown in FIG. 1) of each comparator is coupled to one pixel column, e.g., via one amplifier and one column line. The comparing circuit 14 is used to convert analog pixel signals PXO1, PXO2, PXO3 . . . PXOm into digital signals. For example, each comparator 141 to 14m converts an analog pixel signal into a digital signal based on a ramp signal Vramp (e.g., a voltage signal), e.g., referring to FIG. 2A.

The ramp signal generator 17 is coupled to the other input terminal (e.g., the left input terminal shown in FIG. 1) of each comparator 141 to 14m to provide the ramp signal Vramp to each comparator 141 to 14m. For example referring to FIG. 2A, the ramp signal generator 17 provides, within an auto-zero interval (e.g., T0 to T1), an auto-zero voltage Vref (or called reference voltage) to the voltage line Lramp; next, within an offset interval (e.g., T1 to T2) behind the auto-zero interval T0-T1, the ramp signal generator 17 offsets the ramp signal Vramp to Vofst (=Vramp+offset2); next, within a reset interval (e.g., shown as reset ADC between T2 and T3 in FIG. 2A), a voltage level of the ramp signal Vramp is monotonically decreased to a first predetermined voltage level corresponding to the maximum countable values of the counting circuit 15 in the reset interval T2-T3; next, within a data transfer interval (e.g., T3 to T4) behind the reset interval T2-T3, the ramp signal Vramp is increased to Vofst again; next. within a signal ADC interval (e.g., shown as signal ADC between T4 and T5 in FIG. 2A) behind the data transfer interval T3-T4, the ramp signal Vramp is monotonically decreased to a second predetermined voltage level corresponding to the maximum countable values of the counting circuit 15 in the signal ADC interval T4-T5. That is, a line time T_{Line} of the image sensor 100 covers a time interval between T0 and T5.

The counting circuit 15 includes multiple counters 151 to 15m, e.g., which are implemented by adders, respectively corresponding to the comparators 141 to 14m. The counting circuit 15 is used to count a number of clocks, e.g., shown as CNres in FIG. 2A, at a time point that the ramp signal Vramp reaches/crosses the auto-zero voltage Vref within the reset interval T2-T3 according to a clock signal CLK generated by the clock signal generator 18. The counting circuit 15 is also used to count a number of clocks, e.g., shown as CNsig in FIG. 2A, at a time point that the ramp signal Vramp reaches/crosses a voltage level of a pixel signal within the signal ADC interval T4-T5. By calculating CNsig-CNres, a digital value representing a real pixel signal is obtained, i.e. performing an operation of correlation double sampling (CDS). Details of the CDS are known to the art and thus details thereof are not described herein.

The memory circuit 16 includes multiple memories 161 to 16m, which are implemented by static random access memories (SRAM), the latches, the flip flops or a combination thereof without particular limitations. The memory circuit 16 is used to record count numbers CN outputted by the counting circuit 15, and to output the recorded count numbers CN via an output circuit during the counting circuit 15 is counting the next pixel row.

Please refer to FIG. 2A again, it is seen that the system power VDDAD and the system ground VSSAD are interfered within the reset interval T2-T3 to cause a data transfer error. This interference is induced because the ramp signal Vramp provided to every comparator 141 to 14m is identical such that all comparators 141 to 14m change states at the same time point (e.g., shown as Tcs) as well as all memories 161 to 16m latch data at the same time point Tcs (e.g., in the case that the memory being implemented by latches).

Please refer to FIG. 3, it is a schematic diagram of implementing a dithering auto-zero function of an image sensor 100 according to a first embodiment of the present disclosure, wherein a voltage generator 171 is used to represent the ramp signal generator 17 of the image sensor 100, but the ramp signal generator 17 is not limited to be implemented by the voltage generator 171. The ramp signal generator 17 may use other known ramp signal generators without particular limitations. The present disclosure is to arrange additional current sources to generate a voltage drop on the voltage line Lramp connecting to all comparators 141 to 14m. In one aspect, the voltage generator 171 includes an operation amplifier, a feedback resistor Rfb and a feedback capacitor Cfb as shown in FIG. 3.

As mentioned above, the voltage generator 171 (i.e. the ramp signal generator 17) provides a ramp signal Vramp to the multiple comparators 141 to 14m via the voltage line Lramp, wherein each comparator 141 to 14m includes a first input terminal to receive (e.g., via capacitors C and Cp) the pixel signal PXO, and includes a second input terminal to receive (e.g., via capacitors C and Cp) the ramp signal Vramp.

The image sensor 100 according to the first embodiment of the present disclosure further includes an extraction current source 311 connected to the voltage line Lramp and arranged at downstream of a last comparator 14m among the multiple comparators 141 to 14m to extract a current I₁ from the voltage line Lramp.

The voltage line Lramp has a line resistance (e.g., parasitic resistance), and thus the extraction current generates a voltage drop on the voltage line Lramp. In this way, although the voltage generator 171 provides an auto-zero voltage Vref to the first comparator 141 within the auto-zero interval T0-T1, auto-zero voltages Vref actually provided to every comparator 141 to 14m are different from one another, e.g., shown as multiple auto-zero voltages Vref1 to Vrefm in FIG. 2B, because the extraction current source 311 draws the current I₁ from the voltage line Lramp within the auto-zero interval T0-T1. Meanwhile, because said different auto-zero voltages Vref1 to Vrefm are formed by the voltage drop on the voltage line Lramp, the auto-zero voltages Vref1 to Vrefm provided to every comparator 141 to 14m successively decrease from the first comparator 141 connected to the voltage generator 171 to the last comparator 14m. For example, a voltage at the end of the voltage line Lramp is shown as Vramp-I₁×R in FIG. 3, wherein R is the total line resistance of the voltage line Lramp.

In another aspect, the auto-zero voltages Vref1 to Vrefm provided to every comparator 141 to 14m successively increase from the first comparator 141 connected to the voltage generator 171 to the last comparator 14m, e.g., the supply current source 312 injecting the current I₁ behind the last comparator 14m and the extraction current source 311 drawing out the current I₁ in front of the first comparator 141 (i.e. exchanging positions in FIGS. 3-4), but not limited to. In other words, the auto-zero voltages Vref1 to Vrefm provided to every comparator 141 to 14m successively change from the first comparator 141 connected to the voltage generator 171 to the last comparator 14m.

In this way, because times of state change T_{C1} to T_{Cm} of the comparators 141 to 14m are dispersed, the interference to the system power VDDAD and the system ground VSSAD is alleviated, referring to FIG. 2B.

The times of state change T_{C1} to T_{Cm} are more dispersed when a value of the extraction current I₁ is larger, the value of the extraction current I₁ is preferably limited by a number of maximum countable periods of the ramp signal Vramp within the reset interval T2-T3 to cause the CDS to operate normally.

The extraction current source 311 stops extracting the current from the voltage line Lramp within the offset interval T1-T2 (more specifically at time T1), e.g., controlled by using a switching device SWdi, but not limited to. The deactivation of the extraction current source 311 may be directly controlled by the ramp signal generator 17 without particular limitations.

In addition, in order not to cause the operation amplifier of the voltage generator 171 to provide the extraction current I₁, the image sensor 100 of the first embodiment may further include a supply current source 312 connected to the voltage line Lramp, and arranged between the first comparator 141 among the multiple comparators 141 to 14m and the voltage generator 171. Similarly, the supply current source 312 stops providing the current I₁ to the voltage line Lramp within the offset interval T1-T2 (more specifically at time T1), e.g., controlled by using a switching device SWdi, but not limited to. The deactivation of the supply current source 312 may be directly controlled by the ramp signal generator 17 without particular limitations.

In the first embodiment, the parasitic resistance Rp of the voltage line Lramp is used to generate the voltage drop. Because the parasitic resistance Rp is very small, the extraction current I₁ should be large enough, e.g., several mA, to generate enough difference of the auto-zero voltage Vref corresponding to different pixel columns. Therefore, to reduce the power consumption, the present disclosure further provides an image sensor using a dithering ramp signal and with lower power consumption.

Please refer to FIG. 4, it is a schematic diagram of implementing a dithering auto-zero function of an image sensor 100 according to a second embodiment of the present disclosure, wherein a voltage generator 171 is also used to represent the ramp signal generator 17 of the image sensor 100.

In the second embodiment, the voltage generator 171 is respectively coupled to a second input terminal (e.g., shown as the left input terminal) of every comparator 141 to 14m via a first voltage line Lramp1 and multiple switches SW1, or coupled to the second input terminal of every comparator 141 to 14m via a second voltage line Lramp2 and multiple second switches SW2, wherein the line resistance Rp2 of the second voltage line Lramp2 is larger than, e.g., more than 100 times, the line resistance Rp1 of the first voltage line Lramp1. The extraction current source 411 is connected to the second voltage line Lramp2 and arranged at downstream of the last comparator 14m among the multiple comparators 141 to 14m to extract a current I₂ from the second voltage line Lramp2. A value of the extraction current I₂ is, for example, tens of μA, e.g., smaller than the value of the extraction current I₁ in the first embodiment by more than 100 times. In the second embodiment, the second voltage line Lramp2 is an additionally added line functioned only within the auto-zero interval T0-T1 shown in FIG. 2A.

Please refer to FIG. 2A again, similarly the voltage generator 171 is used to provide an auto-zero voltage Vref to every comparator 141 to 14m within an auto-zero interval T0-T1. The second switch SW2 is conducted within the auto-zero interval T0-T1, but the first switch SW1 is not conducted within the auto-zero interval T0-T1. The second switch SW2 is not conducted within an offset interval T1-T2 (more specifically dis-conducted at time T1), but the first switch SW1 is conducted within the offset interval T1-T2 (more specifically conducted from T1 to T5 to keep the speed of circuit operation). Preferably, the first switch SW1 and the second switch SW2 are not conducted together. The first switch SW1 and the second switch SW2 are, for example, transistor switches.

In this way, when the first switch SW1 is conducted, the first voltage line Lramp1 is coupled to the left input terminal of each comparator 141 to 14m via a first capacitor C1 and a second capacitor C2 connected in parallel. When the second switch SW2 is conducted, the second voltage line Lramp2 is coupled to the left input terminal of each comparator 141 to 14m via the second capacitor C2. The right input terminals of every comparator 141 to 14m are respectively coupled to the column lines C1 to Cm of the pixel columns via the capacitor C (=C1+C2) so as to receive the pixel signals PXO.

Similarly, the extraction current source 411 is used to extract the current I₂ from the second voltage line Lramp2 within the auto-zero interval T0-T1 to cause the auto-zero voltages Vref1 to Vrefm provided to each comparator 141 to 14m to be different from one another, referring to FIG. 2B. For example, the auto-zero voltage difference between two adjacent comparators is ΔVg=(Vramp−Vramp′)×C2/(C1+C2+Cp).

Similarly, in order not to cause the operation amplifier of the voltage generator 171 to provide the extraction current I₂, the image sensor 100 of the second embodiment may further include a supply current source 412 connected to the first voltage line Lramp1 and the second voltage line Lramp2, and arranged between the first comparator 141 among the multiple comparators 141 to 14m and the voltage generator 171 (i.e. the ramp signal generator 17).

The second embodiment achieves the same technical effect but consumes lower power since I₂<I₁.

In addition, the present disclosure further provides an image sensor, which is also described by the image sensor 100 shown in FIG. 1, capable of eliminating quantization noises.

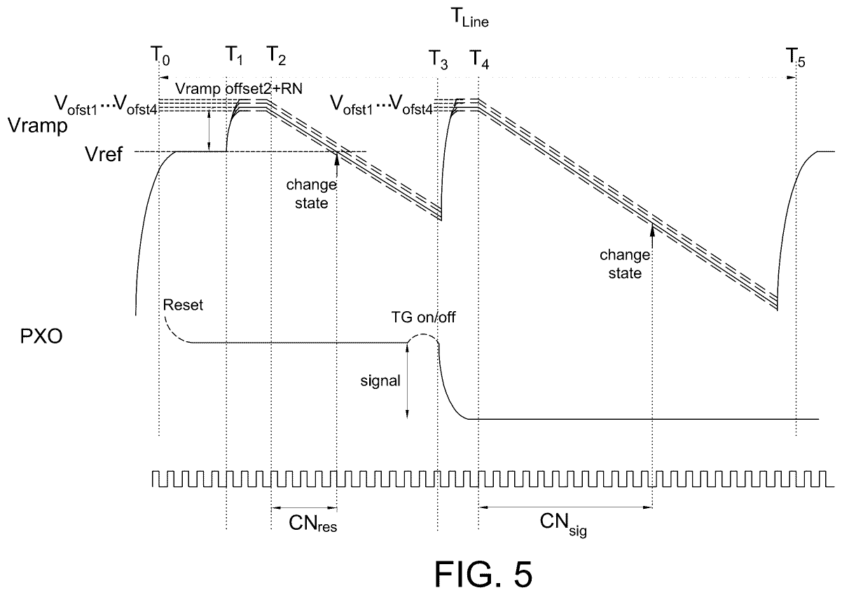

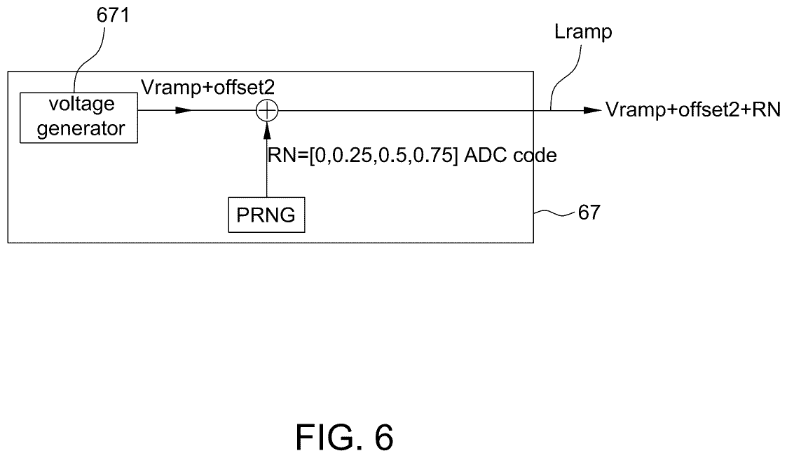

Please refer to FIGS. 5 and 6, FIG. 5 is an operational timing diagram of an image sensor 100 with a dithering function on an offset voltage Vramp+offset2 of a ramp signal according to a third embodiment of the present disclosure; and FIG. 6 is a schematic block diagram of a ramp signal generator 67 of an image sensor 100 according to a third embodiment of the present disclosure. The operation without the dithering function on the offset voltage is referred to FIG. 2A as a comparison.

In the third embodiment, the ramp signal generator 67 is used to provide an auto-zero voltage Vref of a ramp signal Vramp with an auto-zero interval To-T1 via a voltage line Lramp to the left input terminal of every comparator 141 to 14m, e.g., referring to FIGS. 1 and 2A. The voltage generator 671 is used to provide an offset voltage Vofst (=Vramp+offset2) of the ramp signal Vramp within an offset interval T1-T2 via the voltage line Lramp to the left input terminal of every comparator 141 to 14m.

In the third embodiment, the image sensor 100 further includes a random number generator (e.g., shown as PRNG, pseudo random number generator, in FIG. 6) used to provide different random noises RN corresponding to different pixel rows, and the different random noises RN are added to the offset voltage Vofst to cause the offset voltage Vofst of the ramp signal Vramp to form random offset voltages corresponding to different pixel rows, e.g., shown as Vofst1 to Voft4 (=Vramp+offset2+RN) in FIG. 5.

In one aspect, the random noises include 0 times, 0.25 times, 0.5 times and 0.75 times of a voltage difference (e.g., 4 mV, but not limited to) representing one ADC code. The ADC code includes, for example, 8 bits, but not limited to. When the ADC code has higher bits, the voltage difference representing one ADC code may be lower. That is, the voltage difference is determined according to different applications.

It should be mentioned that although FIG. 6 shows that the random number generator PRNG is inside the ramp signal generator 67, it is only intended to illustrate but not to limit the present disclosure. In another aspect, the random number generator PRNG is arranged outside of and independent from the ramp signal generator 67.

As shown in FIG. 5, since the image sensor 100 of the present disclosure takes the correlation double sample (CDS) to calculate real pixel signals, start voltages (i.e. prior to monotonic decreasing) of the random offset voltages Vofst1 to Vofst4 within the sample reset interval T2-T3 and the sample signal interval T4-T5 are identical so as to cancel the random noises RN in calculating CNsig-CNres.

It should be mentioned that a number of and a voltage difference between the random noises RN are not limited to those mentioned herein as long as different Vofst are formed to alleviate the influence of quantization noises.

The main difference between the third embodiment from the first and second embodiments mentioned above is that the first and second embodiments use the dithering function to generate different auto-zero voltages Vref, but the third embodiment uses the dithering function to provide different offset voltages Vofst of the ramp signal Vramp.

It should be mentioned that although the present disclosure is described in the way the ramp signal generator 67 provides the offset voltages Vofst1 to Vofst4 in a random manner, the present disclosure is not limited thereto. In another aspect, the ramp signal generator 67 provides the different offset voltages Vofst1 to Vofst4 in a fixed sequence, e.g., providing Vramp+offset2 to the first pixel row, the fifth pixel row, the ninth pixel row . . . ; providing Vramp+offset2+0.25×(voltage difference of one ADC code) to the second pixel row, the sixth pixel row, the tenth pixel row . . . ; providing Vramp+offset2+0.5×(voltage difference of one ADC code) to the third pixel row, the seventh pixel row, the eleventh pixel row . . . ; and providing Vramp+offset2+0.75×(voltage difference of one ADC code) to the fourth pixel row, the eighth pixel row, the twelfth pixel row . . . ; but not limited to. As long as different offset voltages Vofst1 to Vofst4 are provided corresponding to different pixel rows, the method of providing the different offset voltages Vofst1 to Vofst4 is not particularly limited.

It should be mentioned that the above first and third embodiments are combinable, and the above second and third embodiments are combinable to cause both the auto-zero voltage Vref and the reset voltage Vofst to have different values.

That is, the image sensor 100 of the third embodiment further includes an extraction current source (e.g., referring to the 311 in FIG. 3 and the 411 in FIG. 4) connected to the voltage line (e.g., referring to the Lramp in FIG. 3 and the Lramp2 in FIG. 4), and arranged at downstream of the last comparator 14m among multiple comparators to draw a current from the voltage line. The image sensor 100 of the third embodiment may further include a supply current source (e.g., referring to the 312 in FIG. 3 and the 412 in FIG. 4) connected to the voltage line (e.g., referring to the Lramp in FIG. 3 and the Lramp1 and Lramp2 in FIG. 4), and arranged between the first comparator 141 among multiple comparators and the ramp signal generator 17 to inject a current to the voltage line. Details of these current sources have been described above, and thus are not repeated again.

It should be mentioned that values mentioned in the present disclosure, e.g., including voltage values, current values, a number of bits and numbers of every components, are only intended to illustrate but not to limit the present disclosure.

As mentioned above, because the auto-zero voltage and the offset voltage provided to all comparators are identical in the conventional image sensors, that causes issues of a data transfer error and quantization noises such that longitudinal noises appear in outputted images. Accordingly, the present disclosure further provides an image sensor (e.g., referring to FIG. 1 and FIGS. 3-4) and an operating method of the image sensor (e.g., referring to FIGS. 2B and 5) in which dithering auto-zero voltages or dithering offset voltages of a ramp signal are provided to eliminate or at least alleviate the already known data transfer error or quantization noises.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. An image sensor, comprising:
a pixel array, comprising multiple pixel columns;
multiple comparators, respectively being arranged corresponding to the multiple pixel columns, and one input terminal of each comparator being coupled to one pixel column;
a ramp signal generator, configured to be coupled to the other input terminal of the each comparator via a voltage line to provide a ramp signal to the each comparator; and
an extraction current source, configured to be coupled to the voltage line and arranged at downstream of a last comparator among the multiple comparators to extract a current from the voltage line.

2. The image sensor as claimed in claim 1, wherein
the ramp signal generator is configured to provide an auto-zero voltage to the each comparator within an auto-zero interval, and
the extraction current source is configured to extract the current from the voltage line within the auto-zero interval to cause the auto-zero voltage provided to the each comparator to be different from one another.

3. The image sensor as claimed in claim 2, wherein the ramp signal generator is further configured to offset the ramp signal within an offset interval behind the auto-zero interval.

4. The image sensor as claimed in claim 3, wherein the extraction current source is configured to stop extracting the current form the voltage line within the offset interval.

5. The image sensor as claimed in claim 3, wherein the current extracted by the extraction current source is limited by a number of maximum countable periods on the ramp signal within a reset interval.

6. The image sensor as claimed in claim 3, wherein the auto-zero voltage provided to the each comparator successively changes from a first comparator connected to the ramp signal generator to the last comparator among the multiple comparators.

7. The image sensor as claimed in claim 1, further comprising:
a supply current source, configured to be coupled to the voltage line and arranged between a first comparator among the multiple comparators and the ramp signal generator.

8. An image sensor, comprising:
a pixel array, comprising multiple pixel columns;
multiple comparators, respectively being arranged corresponding to the multiple pixel columns, and one input terminal of each comparator being coupled to one pixel column;
a ramp signal generator, configured to be coupled to the other input terminal of the each comparator via a first voltage line and a first switch, or coupled to the other input terminal of the each comparator via a second voltage line and a second switch, wherein a line resistance of the second voltage line is larger than a line resistance of the first voltage line; and
an extraction current source, configured to be coupled to the second voltage line and arranged at downstream of a last comparator among the multiple comparators to extract a current from the second voltage line.

9. The image sensor as claimed in claim 8, wherein
the ramp signal generator is configured to provide an auto-zero voltage to the each comparator within an auto-zero interval, and
the second switch is conducted within the auto-zero interval but the first switch is not conducted within the auto-zero interval.

10. The image sensor as claimed in claim 9, wherein the ramp signal generator is further configured to offset the ramp signal within an offset interval behind the auto-zero interval.

11. The image sensor as claimed in claim 10, wherein the second switch is not conducted within the offset interval but the first switch is conducted within the offset interval.

12. The image sensor as claimed in claim 9, wherein the extraction current source is configured to extract the current from the second voltage line within the auto-zero interval to cause the auto-zero voltage provided to the each comparator to be different from one another.

13. The image sensor as claimed in claim 8, wherein
when the first switch is conducted, the first voltage line is coupled to the other input terminal of the each comparator via a first capacitor and a second capacitor connected in parallel, and
when the second switch is conducted, the second voltage line is coupled to the other input terminal of the each comparator via the second capacitor.

14. The image sensor as claimed in claim 8, further comprising:
a supply current source, configured to be coupled to the first voltage line and the second voltage line, and arranged between a first comparator among the multiple comparators and the ramp signal generator.

15. An image sensor, comprising:
a pixel array, comprising multiple pixel columns and multiple pixel rows;
multiple comparators, respectively being arranged corresponding to the multiple pixel columns, and one input terminal of each comparator being coupled to one pixel column;
a ramp signal generator, configured to be coupled to the other input terminal of the each comparator via a voltage line to provide an offset voltage of a ramp signal to the each comparator; and
a random number generator, configured to provide different random noises to be added to the offset voltage of the ramp signal corresponding to different pixel rows to cause the offset voltage of the ramp signal to form a random offset voltage corresponding to the different rows.

16. The image sensor as claimed in claim 15, wherein the random noises comprise a 0 times of, a 0.25 times of, a 0.5 times of and a 0.75 times of a voltage difference of one analog-to-digital converter (ADC) code.

17. The image sensor as claimed in claim 16, wherein the ADC code has 8 bits.

18. The image sensor as claimed in claim 15, wherein start voltages of the random offset voltage within a sample reset interval and a sample signal interval of a correlation double sampling are identical.

19. The image sensor as claimed in claim 15, further comprising:
an extraction current source, configured to be coupled to the voltage line and arranged at downstream of a last comparator among the multiple comparators to extract a current from the voltage line.
